(19) United States
(12) Patent Application Publication
(10) Pub. No.: US 2025/0121598 A1
(43) Pub. Date: Apr. 17, 2025

(54) PRINTING APPARATUS

(71) Applicant: CANON KABUSHIKI KAISHA, Tokyo (JP)

(72) Inventors: MIZUHO KOYAMA, Kanagawa (JP); RYOSUKE ARAKI, Kanagawa (JP)

(21) Appl. No.: 18/914,956

(22) Filed: Oct. 14, 2024

(30) Foreign Application Priority Data
Oct. 17, 2023 (JP) 2023-178708

(51) Int. Cl. B41J 2/165

(52) U.S. Cl. CPC B41J 2/16508

(57) ABSTRACT

A printing apparatus has a cap configured to cap a printhead and having a supply port through which a liquid is supplied into the cap, an absorber provided in the cap, and a channel forming member having a first communication channel, the channel forming member being in contact with a bottom surface of the absorber and away from an inner bottom surface of the cap. The volume flow rate of the liquid flowing through the first communication channel is smaller than the volume flow rate of the liquid flowing through the supply port.

### BACKGROUND OF THE INVENTION

### Field of the Invention

The present disclosure relates to a technique for supplying a cleaning liquid to a cap.

### Description of the Related Art

A printing apparatus using a printhead may experience unstable ink ejection due to, e.g., thickening of ink or clogging of ink by evaporation of moisture in the ink in an ejection port. For stable ink ejection, a capping mechanism configured to cap the ejection port surface of the printhead during non-printing mode is used to mitigate thickening of ink. Also, ink may be ejected to the capping mechanism not to print an image but to remove thickened ink in the vicinities of the ejection port, or the ejection port may be suctioned in a capped state to forcibly discharge the ink in the vicinities of the ejection port. The capping mechanism includes an absorber to absorb the discharged ink. Once moisture in ink absorbed in the absorber evaporates, a color material component such as a dye is deposited on the absorber, and such deposits hinder the ink absorptive function.

Japanese Patent Laid-Open No. H8-150722 (hereinafter referred to as Literature 1) discloses a technique for cleaning an absorber in a cap. Literature 1 describes cleaning the absorber with a cleaning liquid supplied into the cap from a supply flow channel communicating with the outside of the cap and discharging liquid inside the absorber through a suction port.

In the configuration where a cleaning liquid is supplied to a cap, the cleaning liquid may fail to be supplied to the absorber properly in a case where the cap is tilted. Specifically, the cleaning liquid supplied may flow toward a discharge port, which is at a low level side, and fail to be supplied to the absorber at a higher level side.

### SUMMARY OF THE INVENTION

A printing apparatus according to an aspect of the present disclosure has: a cap configured to cap a printhead and having a supply port through which a liquid is supplied into the cap; an absorber provided in the cap; and a channel forming member having a first communication channel, the channel forming member being in contact with a bottom surface of the absorber and away from an inner bottom surface of the cap. A volume flow rate of the liquid flowing through the first communication channel is smaller than a volume flow rate of the liquid flowing through the supply port.

Further features of the present disclosure will become apparent from the following description of exemplary embodiments with reference to the attached drawings.

### BRIEF DESCRIPTION OF THE DRAWINGS

FIG. 1 is a schematic diagram showing an example rough configuration of a printing apparatus;

FIG. 2 is a perspective view of a printhead;

FIG. 3 is a perspective view showing the configuration of a cap tray;

FIG. 4 is a schematic diagram showing an overall configuration including the printhead and a capping mechanism;

FIGS. 5A to 5C area diagrams illustrating the capping mechanism;

FIG. 6 is a sectional view illustrating the capping mechanism;

FIG. 7 is a sectional view illustrating the capping mechanism;

FIG. 8 is a schematic diagram illustrating formation of a space;

FIGS. 9A and 9B are diagrams illustrating an example of how a cleaning liquid flows into the capping mechanism from the outside;

FIGS. 10A and 10B are diagrams illustrating an example of how a supplied cleaning liquid is discharged;

FIGS. 11A and 11B are diagrams schematically showing the configuration of the capping mechanism;

FIGS. 12A and 12B are diagrams illustrating advantageous effects;

FIG. 13 is a diagram illustrating pressure loss; and

FIG. 14 is a diagram illustrating a capping mechanism.

### DESCRIPTION OF THE EMBODIMENTS

Embodiments of the present disclosure are described in detail below with reference to the drawings attached hereto. Note that the embodiments below are not intended to limit the matters in the present disclosure, and not all the combinations of the features described in the embodiments below are necessarily essential as the solutions provided by the present disclosure. Note that the same reference number is used to denote the same constituent. Also, the relative positions, shapes, and the like of the constituents described in the embodiments are merely exemplary, and the scope of the present disclosure is not limited only to them.

Note that “print” as referred to in the description of the embodiments below includes not only forming meaningful information such as text or graphics, but also forming an image, a design, a pattern, or the like widely on a sheet. Also, although the following embodiments assume that a sheet (a printing medium) is cut paper, the sheet may be a rolled sheet, a fabric, a plastic film, or the like. Further, “ink” needs to be interpreted broadly and refers to a liquid usable for formation of an image, a design, a pattern, or the like or processing of a sheet by being applied to a sheet, or for treatment of an ink.

### <Overall Configuration of a Printing Apparatus>

An overall configuration of a printing apparatus 100 of the present embodiment is described below with reference to the drawings. Note that in the drawings, arrows X and Y represent horizontal directions that are orthogonal to each other, and an arrow Z represents a vertical direction. An X-direction is a conveyance direction in which a sheet S as a printing medium is conveyed in the printing apparatus 100 as a whole, or is particularly a conveyance direction in which the sheet S is conveyed in a print unit 2300.

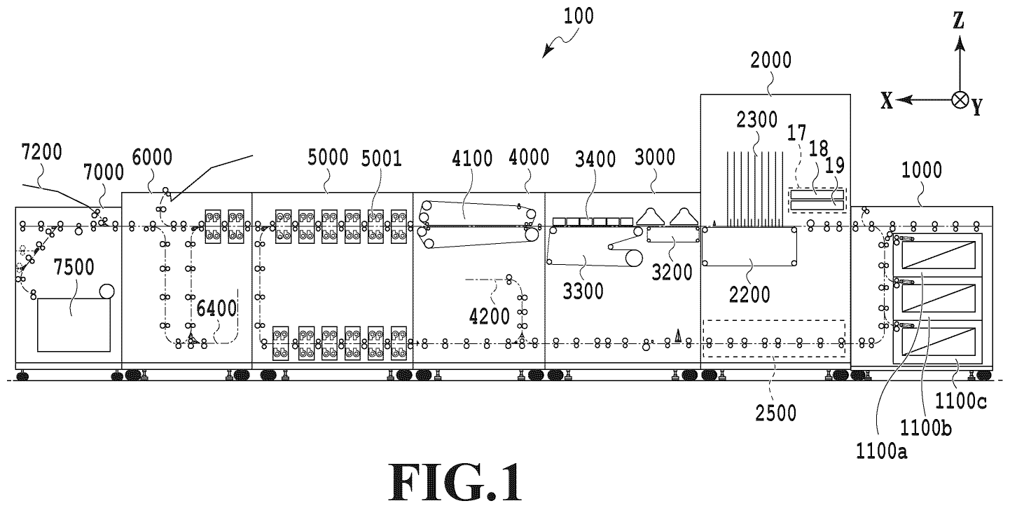

Also, directions in FIG. 1 are defined as follows: an upper side of the apparatus is up, a direction from right to left is an apparatus longitudinal direction, and a direction from the near side to the far side on the paper plane, which is orthogonal to the sheet conveyance direction, is a sheet width direction, with the near side on the paper plane being an apparatus front side and the far side on the paper plane being an apparatus rear side.

FIG. 1 is a schematic diagram showing an example rough configuration of the printing apparatus 100. The printing apparatus 100 is a sheet printing apparatus that manufactures a printed object by forming an ink image on a sheet S using two types of liquid: reaction liquid and ink. The printing apparatus 100 of the present embodiment has a paper feed module 1000, a print module 2000, a drying module 3000, a fixation module 4000, a cooling module 5000, an inversion module 6000, and a paper discharge and stack module 7000. The sheet S in a cut paper shape supplied from the paper feed module 1000 is conveyed along a conveyance path, subjected to processes by the modules, and discharged to the paper discharge and stack module 7000.

In the paper feed module 1000, three storages 1100a to 1100c for housing sheets S are disposed. The storages 1100a to 1100c are each configured to be drawable to the apparatus front side (the near side on the paper plane). The sheets S are fed one at a time from each of the storages 1100a to 1100c by a separation belt and conveyance rollers and is conveyed to the print module 2000. Note that the present disclosure is not limited to having three storages 1100a to 1100c and may be configured having one or two storages or four or more storages.

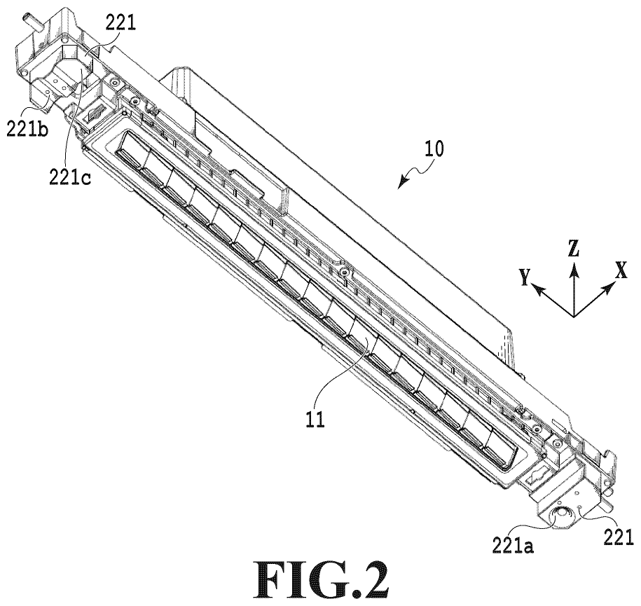

The print module 2000 has a pre-image-formation registration correction unit (not shown), a print belt unit 2200, the print unit 2300, and a maintenance unit 17. The sheet S conveyed from the paper feed module 1000 is corrected in the sheet's tilt and position by the pre-image-formation registration correction unit and is conveyed to the print belt unit 2200. The print unit 2300 is disposed at a position facing the print belt unit 2200 across the conveyance path of the sheet S. The print unit 2300 forms an image on the sheet S conveyed thereto by performing a print process from above on the sheet S using a printhead 10 (see FIG. 2). The sheet S is given clearance from the printhead 10 by being suctioned onto and conveyed by the print belt unit 2200. Also, a plurality of the printheads 10 are arranged side by side in the conveyance direction (the x-direction).

The print unit 2300 of the present embodiment has a total of five line-type printheads 10 corresponding to four colors, Y (yellow), M (magenta), C (cyan), and Bk (black), and P (reaction liquid). Note that the number of types of liquid and the number of printheads are not limited to five. Examples of an inkjet method that can be employed include a method using heat generation elements, a method using piezoelectric elements, a method using electrostatic elements, and a method using MEMS elements. An ink of each color is supplied to the corresponding printhead 10 from an ink tank through an ink tube (neither shown).

The sheet S printed by the print unit 2300 is conveyed by the print belt unit 2200. The printed image can be corrected based on detection of displacement and color density of the image formed on the sheet S by an inline scanner (not shown) disposed downstream of the print unit 2300 in the conveyance direction.

The drying module 3000 has a decoupling unit 3200, a drying belt unit 3300, and a hot air blowing unit 3400. The drying module 3000 is a unit that decreases a liquid component included in the ink applied to the sheet S by the print unit 2300 to enhance the fixation between the sheet S and the ink. The sheet S printed in the print unit 2300 of the print module 2000 is conveyed to the decoupling unit 3200 disposed in the drying module 3000. In the decoupling unit 3200, the sheet S can be conveyed due to wind pressure from above and friction against the belt, and the sheet S is conveyed while being weakly held onto the belt to prevent displacement of the sheet S on the print belt unit 2200 where an ink image is formed. The sheet S conveyed from the decoupling unit 3200 is suctioned onto and conveyed by the drying belt unit 3300 and at the same time, receives hot air from the hot air blowing unit 3400 disposed above the belt. The ink application surface of the sheet S is thereby dried. Note that as the drying method, the method using application of hot air may be combined with a method using application of electromagnetic waves (such as ultraviolet or infrared rays) to the surface of the sheet S or a heat conduction method bringing a heat generator into contact.

The fixation module 4000 has a fixation belt unit 4100. The fixation belt unit 4100 has an upper belt unit and a lower belt unit. The sheet S conveyed from the drying module 3000 is passed through between the heated upper and lower belt units, so that the ink can be fixed onto the sheet S.

The cooling module 5000 has a plurality of cooling units 5001. The cooling units 5001 cool the hot sheet S conveyed from the fixation module 4000. The cooling units 5001 cool the sheet S by taking outside air into a cooling box using a fan to increase pressure inside the cooling box and blowing air discharged from nozzles formed in a conveyance guide against the sheet S. The cooling units 5001 are disposed at both sides of the conveyance path to be able to cool the sheet S from both sides. Also, the cooling module 5000 has a conveyance path switch unit thereinside to be able to switch the conveyance path of the sheet S depending on whether the sheet S is conveyed to the inversion module 6000 or conveyed to a double-side conveyance path used for double-sided printing. In double-sided printing, the sheet S is conveyed to a conveyance path below the cooling module 5000 and is further conveyed along the double-side conveyance path which flows through the fixation module 4000, the drying module 3000, the print module 2000, and the paper feed module 1000. In the print module 2000, the sheet S is conveyed along a double-side conveyance path 2500. Then, the sheet S is conveyed through the pre-image-formation registration correction unit, the print belt unit 2200, and the print unit 2300 in the print module 2000 again and printed by the print unit. A double-side conveyance unit of the fixation module 4000 is provided with an inversion unit 1 (4200) for inverting the sheet S upside down.

The inversion module 6000 has an inversion unit 2 (6400) and can invert the sheet S conveyed thereto upside down using the inversion unit 2 (6400) and can freely change which surface of the sheet S faces upward upon discharge.

The paper discharge and stack module 7000 has a top tray 7200 and a stacker 7500 and aligns and stacks the sheet S conveyed from the inversion module 6000.

The maintenance unit 17 is a unit including mechanisms for restoring the ejection performance of the printheads. Examples of such mechanisms include a capping mechanism that protects an ink ejection surface of the printhead 10, a wiper mechanism that wipes the ink ejection surface, and a suction mechanism that suctions ink in the printhead from the ink ejection surface using negative pressure. Also, the maintenance unit 17 is provided with driving mechanisms and rails (neither shown). Then, the maintenance unit 17 is configured to be able to reciprocate horizontally along the rails, and the maintenance unit 17 moves to a position immediately under the printheads in performing maintenance of the printheads 10 and moves to a position retracted from the position immediately under the printheads in not performing maintenance. The maintenance unit 17 has a capping tray 18 including capping mechanisms and a cleaning tray 19 including wiper mechanisms and suction mechanisms. The capping tray 18 and the cleaning tray 19 are configured to be able to reciprocate horizontally independently of each other using the driving mechanisms and the rails (neither shown). Note that in capping of the printheads 10 with the capping mechanisms, only the capping tray 18 may move, or the entire maintenance unit 17 including the cleaning tray 19 may move.

Note that although the sheet S is cut paper in the example shown for the printing apparatus 100 shown in FIG. 1, the printing apparatus may be configured to have a continuous sheet (roll paper) loaded therein, and the sheet S may be roll paper. Also, the printing apparatus 100 does not have to have the configuration shown in FIG. 1, and any printing apparatus can be used as long as the printing apparatus is configured to cap the printhead 10.

### <Configuration of the Printhead>

FIG. 2 is a perspective view of the printhead 10. As shown in FIG. 2, the printhead 10 has an array of nozzle plates 11 arranged in a longitudinal direction of the printhead (the sheet width direction or the Y-direction), each nozzle plate 11 having a plurality of nozzles that eject ink. Positioning units 221 are provided at both ends of the printhead 10. Specifically, a first abutment portion 221a formed of a recess portion having a conical sloping surface is provided at the near side in the head longitudinal direction (the −Y-direction side). Also, a second abutment portion 221b formed of a V-shape groove portion having two flat surfaces and a third abutment portion 221c formed of a flat surface portion are provided at the far side in the head longitudinal direction (the +Y-direction side).

### <Configuration of the Maintenance Unit>

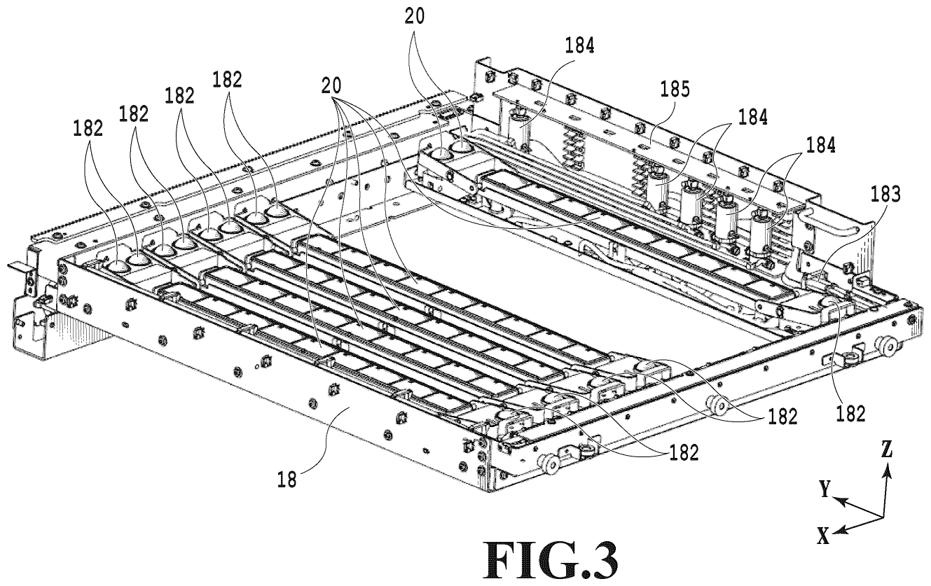

FIG. 3 is a perspective view showing the configuration of the capping tray 18. The configuration of the maintenance unit 17 is described below with reference to FIG. 3.

In the present embodiment, the maintenance unit 17 includes a cap tray 18 where capping mechanisms 20 are disposed and a cleaning tray 19 where cleaning mechanisms (not shown) are disposed. By a drive motor (not shown) and a rail provided at the casing, the cap tray 18 and the cleaning tray 19 are configured to be movable in the apparatus longitudinal direction (the X-direction). Note that a total of five printheads 10 are provided in the present embodiment, and thus, a total of five capping mechanisms 20 and a total of five cleaning mechanisms (not shown) are provided in correspondence to the printheads 10.

As shown in FIG. 3, each capping mechanism 20 in the capping tray 18 has a plurality of spherical printhead positioning members 182 for determining the position of the printhead 10. The printhead positioning members 182 of the capping mechanism 20 are arranged at the front and the rear in the sheet width direction (the Y-direction). Three printhead positioning members 182 are used to position one printhead 10 relative to the capping mechanism 20: one disposed on the near side (the −Y-direction side) and two disposed on the far side (+Y-direction side) of the capping mechanism 20. Positioning between the printhead 10 and the capping mechanism 20 is achieved by abutting the above-described positioning units 221 provided at both ends of the printhead 10 against the printhead positioning members 182 of the capping mechanism 20. By thus positioned relative to the printhead 10, the capping mechanism 20 can protect the nozzle plates 11 of the printhead 10 and perform negative pressure suction using a negative pressure suction mechanism to be described later.

### <Overall Configurations of the Printhead and the Cap>

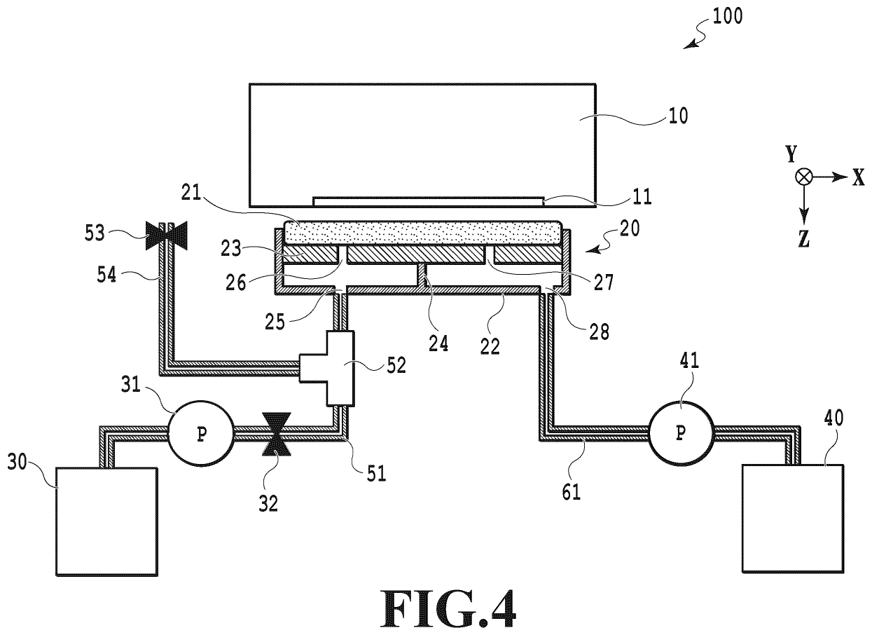

FIG. 4 is a schematic diagram showing an overall configuration including the printhead 10 and the capping mechanism 20 in the present embodiment. The printhead 10 has the nozzle plates 11 where ejection ports are formed. A plurality of ejection ports are disposed at each nozzle plate 11. Also, a print element for ejecting liquid is provided in correspondence to each ejection port. In the present embodiment, a plurality of ejection ports are provided, arranged in the width direction of a printing medium (the Y-direction). In FIG. 4, the ejection ports are arrayed toward the far side of the paper plane (the Y-direction). The Y-direction is also referred to as an ejection port array direction. The ejection ports are also disposed in a direction (the X-direction) intersecting with (orthogonal to) the ejection port array direction. In this way, the longitudinal direction of the printhead 10 is the Y-direction. Thus, like the printhead 10, the longitudinal direction of the capping mechanism 20 configured to cap the printhead 10 is the Y-direction. Hereinbelow, the Y-direction is also referred to as a cap longitudinal direction, and the X-direction intersecting with (orthogonal to) the Y-direction is also referred to as a cap lateral direction.

The capping mechanism 20 has absorbers 21, a first member 22 forming a space inside the capping mechanism 20, a second member 23 forming flow channels, and a partitioning wall 24 dividing the supply side and the discharge side from each other. The first member 22 is provided with a first supply port 25 and first discharge ports 28. The second member 23 is provided with second supply ports 26 and second discharge ports 27. Details of each configuration of the capping mechanism 20 will be described later. The second supply port 26 is also referred to as a first communication channel and the second discharge ports 27 is also referred to as a second communication channel. The second member 23 is also referred to as a channel forming member.

A cleaning liquid tank 30 retains a cleaning liquid, which is a liquid to be supplied into the capping mechanism. A supply pump 31 supplies the cleaning liquid retained in the cleaning liquid tank 30 to the first supply port 25 of the capping mechanism 20 via a supply flow channel 51. A supply valve 32 is configured to open while the supply pump 31 is driven and to close while the supply pump 31 is not driven. A three-way joint 52 provided at the supply flow channel 51 can select whether to make the inside of the capping mechanism communicate with the atmosphere by causing the first supply port 25 of the capping mechanism 20 to communicate with the cleaning liquid tank 30 or with an atmosphere communication channel 54.

A waste liquid tank 40 retains liquid discharged from the capping mechanism 20 (including the cleaning liquid and the ink). Liquid is suctioned from the capping mechanism 20 in the event where a discharge pump 41 is driven with the inside of the cap being in an atmospheric relief state, which is brought about by the three-way joint 52 bringing the first supply port 25 and the atmosphere communication channel 54 into communication and by an atmospheric valve 53 being opened. In this way, the discharge pump 41 is a negative pressure suction mechanism. The suctioned liquid is discharged from the absorbers 21 into the waste liquid tank 40 through the second discharge ports 27, the first discharge ports 28, and a discharge flow channel 61.

Control of cleaning of the capping mechanism 20 using a cleaning liquid is described. First, with the three-way joint 52 bringing the cleaning liquid tank 30 and the first supply port 25 of the capping mechanisms 20 into communication, the supply valve 32 is opened, and the supply pump 31 is driven. This causes the cleaning liquid to be pumped and fed into the capping mechanism 20 from the cleaning liquid tank 30. In the present embodiment, the amount of cleaning liquid to supply from the cleaning liquid tank 30 is controlled so that the cleaning liquid will not overflow from the absorbers 21. For example, the supply pump 31 is driven for a predetermined period of time to control the amount of cleaning liquid supplied. Once a predetermined amount of cleaning liquid is supplied, the driving of the supply pump 31 is stopped, and the supply valve 32 is closed. After that, the three-way joint 52 switches the communication state to the state where the first supply port 25 communicates with the atmosphere communication channel 54, and the atmospheric valve 53 is opened to bring the first supply port 25 into the atmospheric relief state. Then, as a result of driving the discharge pump 41, the liquid in the capping mechanism 20 is discharged to the waste liquid tank 40. In this way, in the present embodiment, supply of the cleaning liquid is controlled, and then, discharge of the cleaning liquid is controlled. In other words, the supply control and the discharge control are performed alternately. However, the present disclosure is not limited to this example, and the supply control and the discharge control may be performed simultaneously. Note that the driving of the pumps, the opening and closing of the valves, and the switching of the three-way joint 52 are performed by a control unit (not shown).

Ink used in the printhead 10 of the present embodiment has the property to easily solidify. Hence, the ink absorbed by the absorbers 21 too is in an easily solidifying state. Thus, in the present embodiment, the absorbers 21 are cleaned using the cleaning liquid. Note that the cleaning liquid has not only the function to clean the absorber 21 but also the function to clean the inner wall, a space, flow channels, and the like inside the capping mechanism 20.

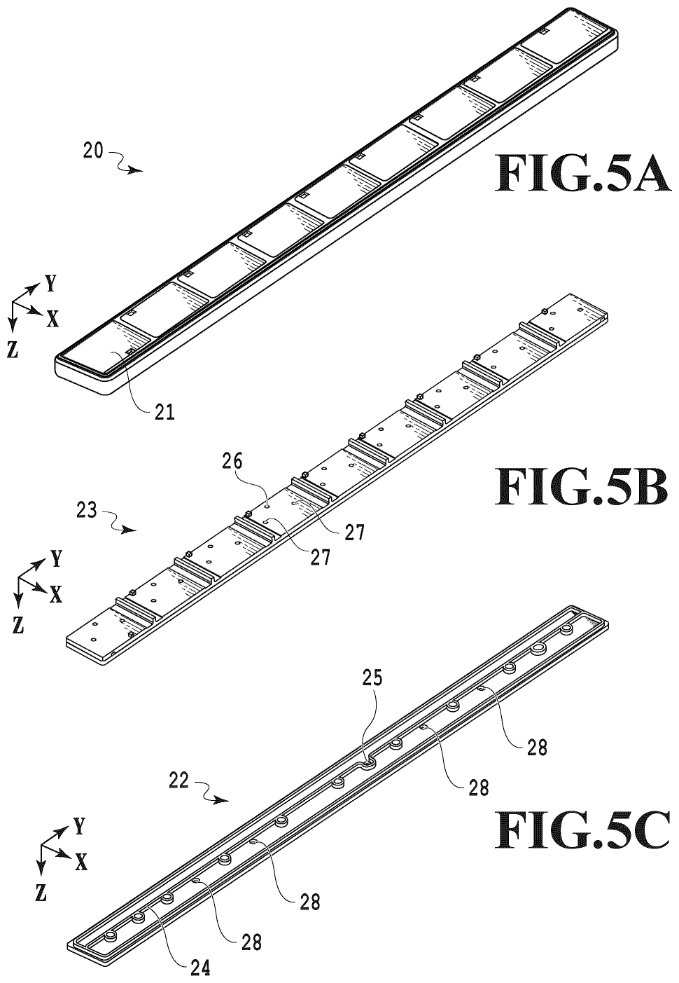

FIGS. 5A to 5C are diagrams illustrating the capping mechanism 20. FIG. 5A is a perspective view of the capping mechanism 20, and the absorbers 21 are provided at locations facing the nozzle plates 11 of the printhead 10. The absorbers 21 are each formed of a porous body such as urethane foam, a sintered body, or a fiber net. In the present embodiment, a plurality of absorbers 21 are provided in respective partitioned areas. In the present embodiment, the plurality of absorbers 21 are disposed in the cap longitudinal direction (Y-direction). The absorbers 21 retain liquid, keeping the inside of the capping mechanism 20 high in moisture to suppress evaporation of moisture in the ink in the printhead 10 and minimize thickening of the ink. The liquid retained in the absorber 21 is the cleaning liquid and the ink discharged from the printhead 10.

FIG. 5B is a perspective view of the second member 23 extracted from the capping mechanism 20. The second member 23 form zones to house the respective absorbers 21. The second supply ports 26 and the second discharge ports 27 are provided in each zone. In the present embodiment, one second supply port 26 and two second discharge ports 27 are provided in each zone. The second supply ports 26 are provided at locations including both ends of the capping mechanism 20 in the longitudinal direction of the capping mechanism 20. Also, the plurality of second supply ports 26 are provided so that the distances between the second supply ports 26 may be equal in the longitudinal direction of the capping mechanism 20.

FIG. 5C is a perspective view of the first member 22 extracted from the capping mechanism 20. The first member 22 is provided with the first supply port 25 at substantially the center portion in the cap longitudinal direction. The capping mechanism 20 is also provided with the plurality of first discharge ports 28. The plurality of first discharge ports 28 are provided, arranged in the cap longitudinal direction. The first member 22 is provided with the partitioning wall 24. The partitioning wall 24 is a wall for partitioning the first member 22 into the cleaning liquid supply side and the cleaning liquid discharge side. The partitioning wall 24 extends in the cap longitudinal direction, partitioning the first member 22 in the cap lateral direction into the cleaning liquid supply side and the cleaning liquid discharge side.

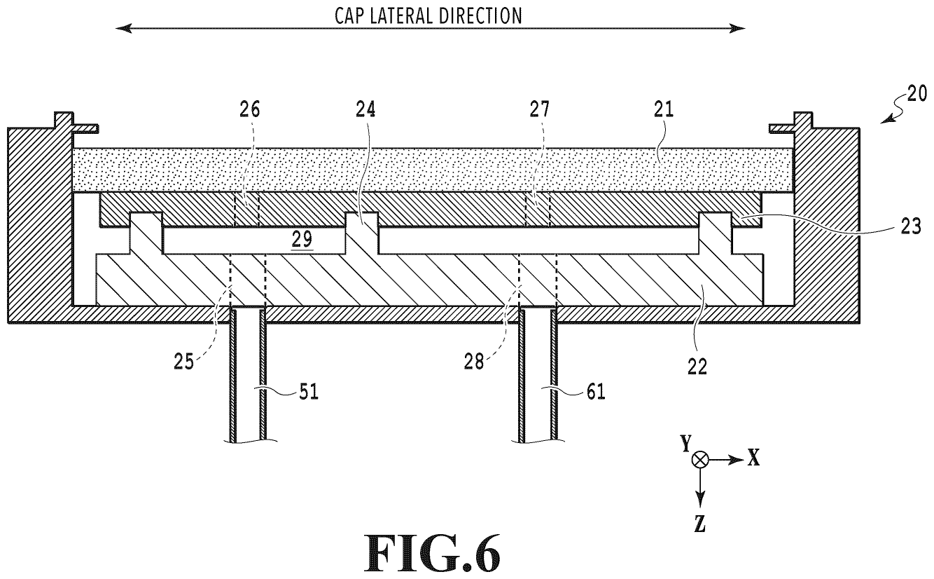

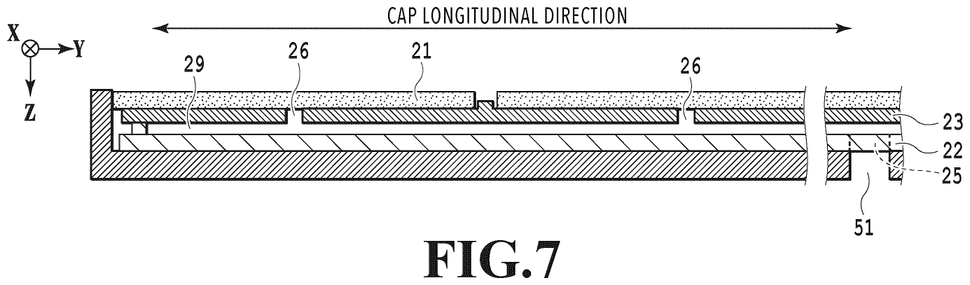

FIGS. 6 and 7 are sectional views illustrating the capping mechanism 20. FIG. 6 is a sectional view taken in the cap lateral direction. FIG. 7 is a sectional view taken in the cap longitudinal direction, showing the supply side. As shown in FIGS. 6 and 7, the second member 23 is a member in contact with the bottom surfaces (the lower surfaces) of the absorbers 21. A space 29 is formed between the first member 22 and the second member 23. Liquid supplied to the first supply port 25 via the supply flow channel 51 flows through the space 29 and flows into each second supply port 26. In the present embodiment, the volume flow rate of the cleaning liquid flowing through the second supply ports 26 is smaller than that of the cleaning liquid flowing through the first supply port 25 (the supply flow channel 51) until all the second supply ports 26 provided at the second member 23 are filled with the cleaning liquid. For example, in the present embodiment, the pressure loss of the cleaning liquid flowing through the second supply ports 26 is larger than that of the cleaning liquid spreading into the space 29 formed between the first member 22 and the second member 23. With such a configuration, even in a case where the capping mechanism 20 is tilted, all the absorbers 21 can be entirely filled with the cleaning liquid, including the absorbers 21 at the higher locations.

Also, as shown in FIG. 6, the space 29 is partitioned by the partitioning wall 24 into a space on the cleaning liquid supply side and a space on the cleaning liquid discharge side. The partitioning wall 24 is provided in the capping mechanism 20, extending in the cap longitudinal direction.

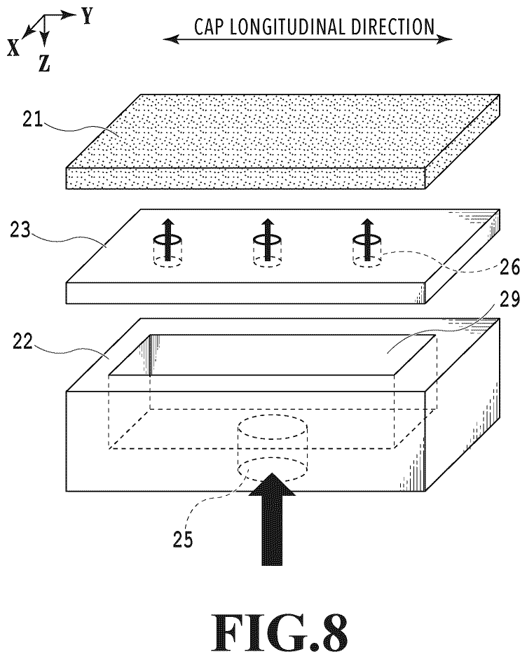

FIG. 8 is a schematic diagram illustrating the formation of the space 29 in the present embodiment. Note that for simplification, FIG. 8 schematically shows the configuration of the supply side. As shown in FIG. 8, the first member 22 forms the space 29. The second member 23 where the second supply ports 26 are formed is disposed on the first member 22 (on the printhead 10 side), closing the space 29. Then, the absorbers 21 are disposed on the second member 23 so that the upper surface of the second member 23 may be in contact with the lower surfaces of the absorbers 21.

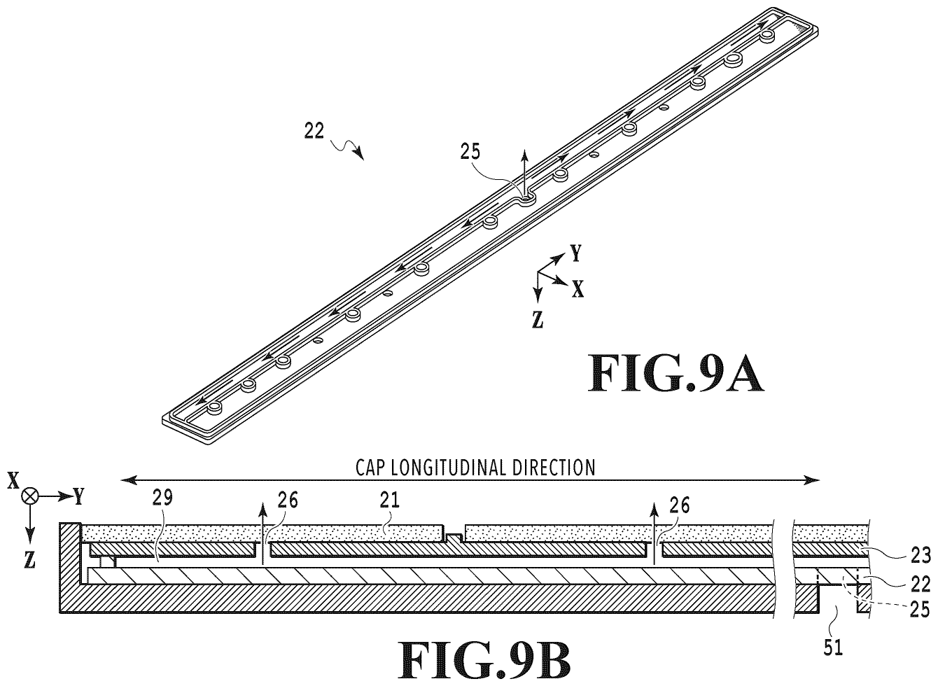

FIGS. 9A and 9B are diagrams illustrating an example of how the cleaning liquid flows into the capping mechanism from the outside of the capping mechanism 20. As shown in FIG. 9A, the cleaning liquid flows in from the first supply port 25 provided at the first member 22 substantially at its center in the cap longitudinal direction. The cleaning liquid flows through the space 29 between the first member 22 and the second member 23 and flows out into the absorbers 21 from the respective second supply ports 26.

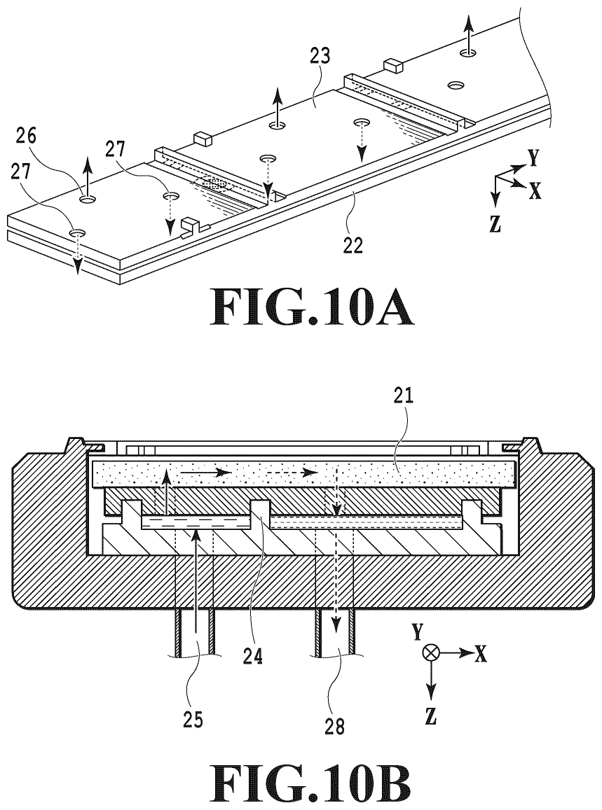

FIGS. 10A and 10B are diagrams illustrating an example of how the cleaning liquid supplied is discharged. FIG. 10A is a diagram extracting the first member 22 and the second member 23. FIG. 10B is a sectional view of the capping mechanism 20 seen from the lateral direction. As shown in FIGS. 10A and 10B, in each zone, the cleaning liquid from the second supply port 26 reaches the absorber 21. Then, liquid is suctioned from the absorber 21 by driving of the discharge pump 41. Specifically, the cleaning liquid that cleaned the absorber 21 and liquid absorbed in the absorber 21 including ink pass through the second discharge ports 27, flow through the space 29 on the discharge side, and is discharged from the first discharge ports 28 to the waste liquid tank 40 through the discharge flow channel 61.

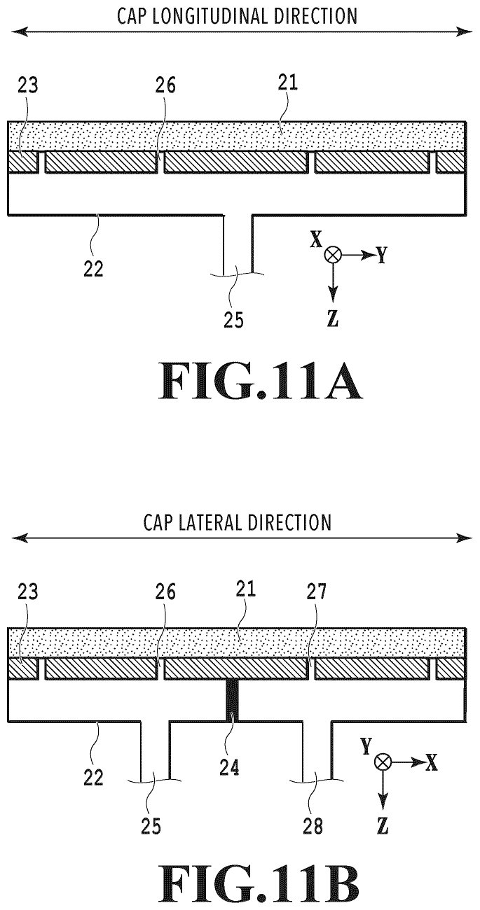

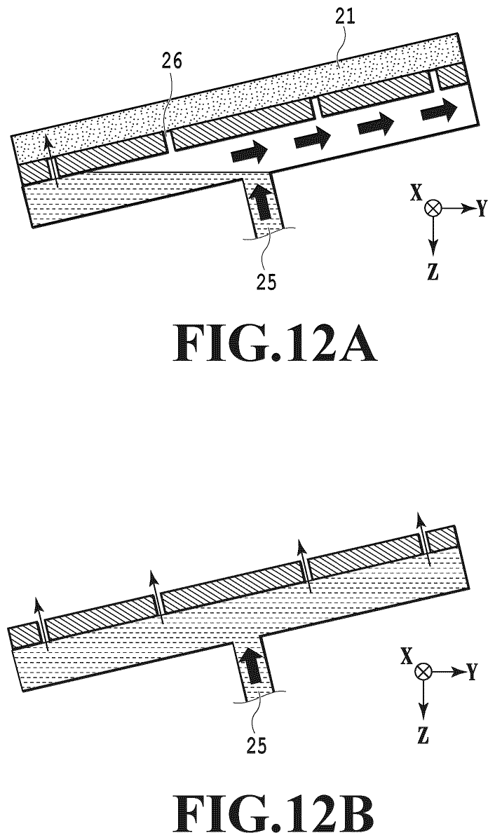

FIGS. 11A and 11B are diagrams schematically showing the configuration of the capping mechanism 20 described above. FIG. 11A is a sectional view taken in the cap longitudinal direction. FIG. 11B is a sectional view taken in the cap lateral direction. FIGS. 12A and 12B are diagrams showing the advantageous effects of the present embodiment.

As shown in FIGS. 11A and 11B, the capping mechanism 20 has the first supply port 25, the first discharge ports 28, and the partitioning wall 24 and has the first member 22 forming the space 29. The capping mechanism 20 also has the second member 23 including the second supply ports 26 and the second discharge ports 27. The second member 23 is in contact with the bottom surfaces of the absorbers 21. Then, the capping mechanism 20 is configured such that the volume flow rate of the cleaning liquid flowing through the second supply ports 26 may be smaller than that of the cleaning liquid flowing through the first supply port 25 (the supply flow channel 51) until all the second supply ports 26 are filled with the liquid. Thus, as shown in FIGS. 12A and 12B, the cleaning liquid can be supplied properly to the absorbers 21 located upward in the tilted capping mechanism 20 as well. Conversely, in a case where the volume flow rate of the cleaning liquid flowing through the second supply ports 26 is equal to or larger than that of the cleaning liquid flowing through the first supply port 25 until all the second supply ports 26 are filled with the liquid, the cleaning liquid flowing in from the second supply port 26 located downward moves out of the capping mechanism 20 via the absorber 21. The lower surface of the second member 23 is spaced away from the inner bottom surface of the first member 22. The space 29 is thus formed. Note that an example where the first member 22 is a separate member from the outer frame of the capping mechanism 20 is depicted in FIG. 5C, as shown in FIGS. 11A and 11B, the first member 22 may be the same member as the frame of the capping mechanism 20.

As shown in FIG. 12A, the cleaning liquid flowing in from the first supply port 25 flows out from the second supply port 26 located downward in the gravitational direction in a tilted state to the corresponding absorber 21. Meanwhile, because the volume flow rate of the cleaning liquid flowing through the second supply ports 26 is smaller than that of the cleaning liquid flowing through the first supply port 25 until all the second supply ports 26 are filled with the liquid, the cleaning liquid is retained more and more in the tilted space 29 upward in the gravitational direction. Thus, the cleaning liquid that does not pass through the second supply port 26 located downward due to a tilt reaches the second supply port 26 located upward, and thus, the cleaning liquid sequentially passes through the upper second supply ports 26. Lastly, as shown in FIG. 12B, even in a state where the capping mechanism 20 is tilted, the cleaning liquid flows out to all the second supply ports 26 and can be supplied to the absorbers 21 properly. Note that after all the second supply ports 26 are filled with the liquid, the volume flow rate of the cleaning liquid flowing through the second supply ports 26 becomes equal to that of the cleaning liquid flowing through the first supply port 25.

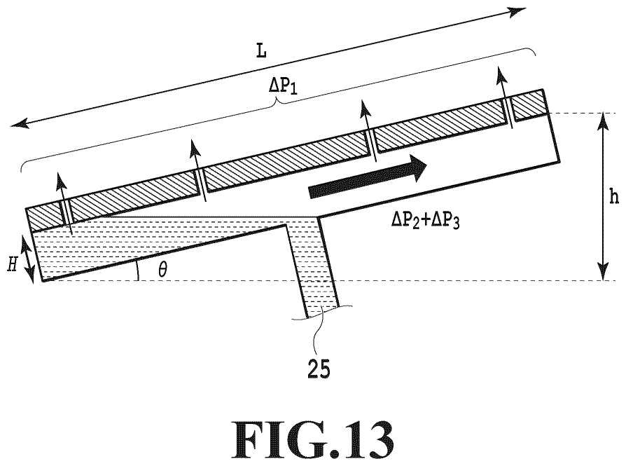

FIG. 13 is a diagram illustrating a pressure loss in the capping mechanism 20. In FIG. 13, ΔP₁ is a flow-channel pressure loss [Pa] of liquid flowing out from the second supply ports 26, ΔP₂ is a flow-channel pressure loss [Pa] of liquid spreading into a storage space (the space 29), and ΔP₃ is a pressure loss [Pa] due to a height difference caused by the tilt of the capping mechanism 20. Formula 1 shows their relation:

$$Δ {P}_{1} > Δ {P}_{2} + Δ {P}_{3} . \qquad ( Formula 1 )$$

In this way, the pressure loss of the cleaning liquid flowing through the second supply ports 26 is larger than the pressure loss of the cleaning liquid spreading into the space 29 formed between the first member 22 and the second member 23. Note that ΔP₁ is found by Formula 2 below, ΔP₂ is found by Formula 3 below, and ΔP₃ is found by Formula 4 below.

$$Δ {P}_{1} = {\sum }_{i = 1}^{n} {ζ}_{i} \frac{ρ {v}_{i}^{2}}{2} \qquad ( Formula 2 )$$

$$Δ {P}_{2} = {ζ}_{2} \frac{ρ {v}_{2}^{2}}{2} \qquad ( Formula 3 )$$

$$Δ {P}_{3} = ρ gh = ρ g ( L sin θ + H cos θ ) \qquad ( Formula 4 )$$

Note that the variables are defined as follows.
ζᵢ: loss factor of the second supply port
ζ₂: loss factor of the storage space
v₁: flow velocity [m/s] at the second supply port
v₂: flow velocity [m/s] at the storage space
n: the number [count] of second supply ports
ρ: density [kg/m³] of the cleaning liquid
L: distance (m) of the storage space in the longitudinal direction
H: height [m] of the storage space
g: acceleration of gravity [m/s²]
θ: tilt of the cap [°]

As thus described, according to the present embodiment, the cleaning liquid can be supplied properly to the absorbers 21 in the capping mechanism 20. As described above, in the present embodiment, the volume flow rate of the cleaning liquid flowing through the second supply ports 26 is smaller than that of the cleaning liquid flowing through the first supply port 25 (the supply flow channel 51) until all the second supply ports 26 are filled with the liquid. For example, in the present embodiment, the pressure loss of the cleaning liquid flowing through the second supply ports 26 is larger than the pressure loss of the cleaning liquid spreading into the space 29 formed between the first member 22 and the second member 23. This configuration makes it possible for all the absorbers 21 to be filled with the cleaning liquid properly, including the absorbers 21 at a higher location, even in a case where the capping mechanism 20 is tilted.

In the example described above, the volume flow rate of the cleaning liquid flowing through the second supply ports 26 is smaller than that of the cleaning liquid flowing through the first supply port 25 (the supply flow channel 51), and the partitioning wall 24 is provided. However, the present disclosure is not limited to this example. The partitioning wall 24 does not have to be provided.

Also, although the first member 22 and the second member 23 are separate members in the example described above, the first member 22 and the second member 23 may be the same member. Also, although the first member 22 includes the partitioning wall 24 in the example described above, the second member 23 may include the partitioning wall 24. The partitioning wall 24 may be formed of a separate member from the first member 22 or the second member 23.

In the embodiment described above, an example where the pressure loss at the second supply ports 26 is large is described as an example where the second member 23 has the second supply ports 26 and the second discharge ports 27, and the volume flow rate of the cleaning liquid flowing out to the second supply ports 26 is smaller than that of the cleaning fluid flowing through the first supply port 25. The second member 23 having the second supply ports 26 does not necessarily have to be used as long as the volume flow rate of the cleaning liquid supplied from the first member 22 to the absorbers 21 is smaller than that of the cleaning liquid flowing through the first supply port 25.

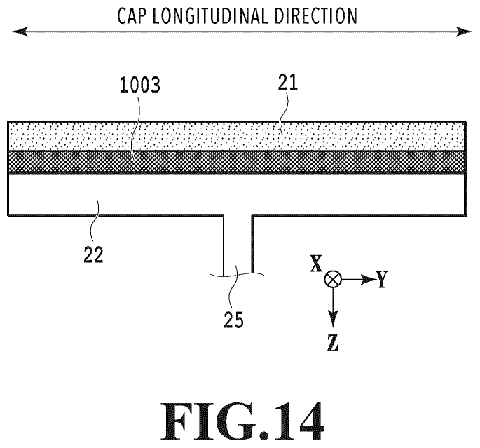

FIG. 14 is a diagram illustrating the capping mechanism 20 in the present embodiment. In the present embodiment, a third member 1003 is provided in place of the second member 23. Like the second member 23, the third member 1003 too is in contact with the lower surfaces of the absorbers 21. Also, the third member 1003 is not in contact with the inner bottom surface of the first member 22, and a space (a storage space) is formed between the third member 1003 and the first member 22.

The third member 1003 is formed of a porous member. Thus, a pressure loss is large similarly to the second supply ports 26 described in the first embodiment, and the volume flow rate of the cleaning liquid supplied from the first member 22 to the absorbers 21 is smaller than that of the cleaning liquid flowing through the first supply port 25. Thus, even in a case where the capping mechanism 20 is tilted, the cleaning liquid can be properly supplied to the absorbers 21 in the capping mechanism 20.

In the examples described in the above embodiments, a single first supply port 25 is provided at a center part in the cap longitudinal direction. Such a configuration enables the cleaning liquid to be supplied efficiently to all the absorbers 21 in the capping mechanism 20. However, the present disclosure is not limited to this example, and a plurality of first supply ports 25 may be provided. In this case, it is preferable that the plurality of first supply ports 25 be disposed so that the cleaning liquid can be supplied efficiently to the entire capping mechanism 20. Note that in a case where a plurality of first supply ports 25 are provided, the capping mechanism 20 is configured so that the total amount of the volume flow rates of the cleaning liquid flowing through the respective first supply ports 25 may be larger than the total amount of the volume flow rates of the cleaning liquid flowing through the respective second supply ports 26. Also, the first supply port 25 does not have to be provided at the bottom surface of the capping mechanism 20 and may be provided at a side surface of the capping mechanism 20 or at a corner portion between a side surface and the bottom surface of the capping mechanism 20. Likewise, in a case where the capping mechanism 20 has a plurality of first supply ports 25, the first supply ports 25 may be provided at any one of the bottom surface, a side surface, or a corner portion of the capping mechanism 20, and may be provided at, for example, both of the bottom surface and the side surface.

Also, in the examples described in the above embodiments, the partitioning wall 24 is provided in the capping mechanism 20, extending in the cap longitudinal direction. However, the present disclosure is not limited to this example as long as the space 29 in the capping mechanism 20 is divided into the supply side and the discharge side. For example, in a case where the capping mechanism 20 is configured in such a manner as to be divided into the supply side and the discharge side in the cap longitudinal direction, the partitioning wall 24 may be provided to extend in the cap lateral direction. Also, although the printhead 10 and the capping mechanism 20 have the longitudinal direction in the examples described in the above embodiments, they may be substantially square in shape and not have a longitudinal direction.

Also, in the example described in the first embodiment, the partitioning wall 24 connects the first member 22 and the second member 23 and partitions the first member 22 completely into the supply side and the discharge side. However, the present disclosure is not limited to this example. A gap may be formed between the second member 23 and the partitioning wall 24, the gap being of a size such that the cleaning liquid does not move from the supply side to the discharge side in the space 29 because of a pressure loss.

Also, in the examples described in the above embodiments, a plurality of absorbers 21 are provided in the cap longitudinal direction, and the second supply ports 26 are provided in correspondence to the plurality of absorbers 21. However, the present disclosure is not limited to this example. For example, a single absorber 21 may be provided, extending in the cap longitudinal direction.

Also, although a cleaning liquid is supplied into the cap in the examples described in the above embodiments, liquid supplied is not limited to a cleaning liquid. Specifically, a liquid not for cleaning purposes may be used.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-178708, filed Oct. 17, 2023, which is hereby incorporated by reference wherein in its entirety.

What is claimed is:

1. A printing apparatus comprising:
a cap configured to cap a printhead and having a supply port through which a liquid is supplied into the cap;
an absorber provided in the cap; and
a channel forming member having a first communication channel, the channel forming member being in contact with a bottom surface of the absorber and away from an inner bottom surface of the cap, wherein
a volume flow rate of the liquid flowing through the first communication channel is smaller than a volume flow rate of the liquid flowing through the supply port.

2. The printing apparatus according to claim 1, wherein
the channel forming member has a plurality of the first communication channels, and
the volume flow rate of the liquid flowing through the first communication channels is smaller than the volume flow rate of the liquid flowing through the supply port until all the first communication channels are filled with the liquid.

3. The printing apparatus according to claim 2, wherein
a pressure loss of the liquid flowing through the first communication channels is larger than a pressure loss of the liquid spreading into a space formed between the cap and the channel forming member.

4. The printing apparatus according to claim 2, wherein
the cap has
a discharge port through which the liquid is discharged from the cap and
a partitioning wall configured to partition a space formed between the cap and the channel forming member.

5. The printing apparatus according to claim 4, wherein
the channel forming member includes a second communication channel different from the first communication channels, and
the partitioning wall partitions the space formed between the cap and the channel forming member into a space connected to the supply port and the first communication channels and a space connected to the discharge port and the second communication channel.

6. The printing apparatus according to claim 5, wherein
a plurality of the second communication channels are provided in a longitudinal direction of the cap.

7. The printing apparatus according to claim 6, wherein
the plurality of second communication channels are provided in such a manner that distances between the second communication channels are equal in the longitudinal direction of the cap.

8. The printing apparatus according to claim 4, wherein
the partitioning wall extends in a longitudinal direction of the cap.

9. The printing apparatus according to claim 4, wherein
the partitioning wall and the channel forming member are a same member.

10. The printing apparatus according to claim 4, wherein
the partitioning wall and the cap are a same member.

11. The printing apparatus according to claim 1, wherein
after being supplied into the cap by flowing from an outside of the cap through the supply port, the liquid flows through the first communication channel and is supplied to the absorber.

12. The printing apparatus according to claim 1, wherein
the supply port is provided at the bottom surface of the cap.

13. The printing apparatus according to claim 1, wherein
the supply port is provided at a center portion of the cap in a longitudinal direction of the cap.

14. The printing apparatus according to claim 1, wherein
a plurality of the first communication channels are provided in a longitudinal direction of the cap.

15. The printing apparatus according to claim 1, wherein
a plurality of the absorbers are provided in a longitudinal direction of the cap, and
the first communication channel is provided at a position corresponding to each of the plurality of absorbers.

16. The printing apparatus according to claim 14, wherein
the first communication channels are provided at both ends of the cap in the longitudinal direction of the cap.

17. The printing apparatus according to claim 14, wherein
the plurality of first communication channels are provided in such a manner that distances between the first communication channels are equal in the longitudinal direction of the cap.

18. The printing apparatus according to claim 1, wherein
the cap and the channel forming member are a same member.
